(19) United States
(12) Patent Application Publication
(10) Pub. No.: US 2007/0149165 A1
(43) Pub. Date: Jun. 28, 2007

(54) Board layout structure of digital broadcast receiving portion

(75) Inventor: Satoshi Katayama, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/634,272

(22) Filed: Dec. 6, 2006

(30) Foreign Application Priority Data
Dec. 8, 2005 (JP) 2005-354747

(51) Int. Cl. H04B 1/08

(52) U.S. Cl. 455/349

(57) ABSTRACT

The invention provides a board layout structure of a digital broadcast receiving portion, wherein mutual positional relation between a digital signal demodulation unit and a digital tuner is interchangeable between right and left. An IF input terminal of a digital signal demodulation unit is placed at a center of a connector so that the IF input terminal can be electrically connected to a digital tuner by pattern wiring of fixed length whether the digital tuner is placed to the right or to the left of the digital signal demodulation unit so as to give even digital broadcast receiving performance in either case.

The present application is based on and claims priority of Japanese patent application No. 2005-354747 filed on Dec. 8, 2005, the entire contents of which are hereby incorporated by reference.

### BACKGROUND OF THE INVENTION

1. Field of the Invention

The present invention relates to a board layout structure of a digital broadcast receiving portion, wherein mutual positional relation between a digital signal demodulation unit and a digital tuner is interchangeable between right and left.

2. Description of the Related Art

Conventionally, various methods are disclosed as to aboard layout structure of a digital tuner and a digital signal demodulation unit necessary for a digital broadcast receiving portion.

For instance, Japanese Patent Laid-Open Publication No. 2002-152063 (Patent Document 1) discloses a method whereby, on placing the digital signal demodulation unit and a tuner unit, their ground patterns are placed to be mutually opposed by concentrating analog signal terminals on ends in the same direction and concentrating digital signal terminals on the other ends to separate an area where the analog signal terminals are concentrated from an area where the digital signal terminals are concentrated so as to prevent interference by noise generated by both sides.

As for a general digital signal demodulation unit, an IF input terminal for inputting a digital IF signal of a connector for electrically connecting a circuit board provided to the digital signal demodulation unit is positioned on an end side of the connector as shown in FIGS. 5 and 6. This is related to a position of an output portion for the digital IF signal of a digital tuner. The digital IF signal is increasingly influenced by exogenous noise in proportion to length of pattern wiring for electrically connecting the IF input terminal to an output portion for the digital IF signal of the digital tuner for outputting the digital IF signal. Thus, it is intended to suppress attenuation of output of the digital IF signal by rendering the pattern wiring shorter as shown in FIG. 7.

According to the method of patent document 1, however, the digital signal demodulation unit has a shield for preventing interference of the noise mounted only on one surface thereof in order to curb costs. Therefore, in the case where right and left must be reversed in a positional relation between the digital tuner and the digital signal demodulation unit in terms of a layout of the circuit board, the shield is not positioned oppositely to the digital tuner and noise interference of the digital signal demodulation unit occurs if their respective regions having the analog signal terminals concentrated therein and regions having the digital signal terminals concentrated therein are placed in the same direction. For this reason, the structure of one digital signal demodulation unit cannot be applied to an electronic device capable of receiving various digital broadcasts so that it has been difficult to render the digital signal demodulation unit as a component.

As for a placement position of an IF input terminal provided to the conventional digital signal demodulation unit, in the case of placing the digital tuner shown in FIG. 7 at a right end as in a board layout structure shown in FIG. 8 rather than placing it at a left end, the side having the shield mounted thereon is not opposite to the digital tuner and the noise generated by the digital tuner interferes with the digital signal demodulation unit even if the digital signal demodulation unit is placed to the left of the digital tuner. To prevent this, if the shield is placed oppositely to the digital tuner as in the board layout structure shown FIG. 9, the noise interference can be prevented by the shield. However, the pattern wiring for electrically connecting the digital IF signal output portion of the digital tuner to the IF input terminal of the digital signal demodulation unit becomes longer than the case of the board layout structure of FIG. 7 so that it may cause some trouble in digital broadcast receiving performance.

### SUMMARY OF THE INVENTION

The present invention has been made in view of the problems, and provides a board layout structure of a digital broadcast receiving portion, wherein mutual positional relation between a digital signal demodulation unit and a digital tuner is interchangeable between right and left so as to suppress limitation on the layout of electronic components on a circuit board.

A board layout structure of a digital broadcast receiving portion according to a first aspect is a circuit board including on one surface a digital signal demodulation unit having a shield for preventing noise and a digital tuner for receiving digital airwaves and obtaining a signal, wherein an IF input terminal provided to a connector for electrically connecting to the circuit board of the digital signal demodulation unit is placed at a center of the connector so that mutual positional relation between the digital tuner and the digital signal demodulation unit on the circuit board is interchangeable between right and left.

According to a configuration of the first aspect, in the case of mounting the digital signal demodulation unit to have the shield of the digital signal demodulation unit on the digital tuner side for the sake of preventing the noise generated by the digital tuner, it is possible, by placing the IF input terminal of the digital signal demodulation unit at the center of the connector, to keep a constant length of pattern wiring for electrically connecting the IF input terminal of the digital signal demodulation unit to an IF output portion of the digital tuner whether the mutual positional relation between the digital tuner and the digital signal demodulation unit is on the right or on the left.

The board layout structure of a digital broadcast receiving portion according to a second aspect is the board layout structure of a digital broadcast receiving portion according to the first aspect, wherein the shield is formed to contact an end of the digital signal demodulation unit and seal the connector and electronic components.

According to the configuration of the second aspect, the shield is rendered approximately U-shaped. It is thereby possible, on placing the digital signal demodulation unit at a position adjacent to the digital tuner, to securely prevent digital noise to the digital signal demodulation unit from the digital tuner whether the digital signal demodulation unit is placed on the right or on the left of the digital tuner.

### BRIEF DESCRIPTION OF THE DRAWINGS

FIG. 1 is a perspective view showing a configuration of a digital signal demodulation unit, which shows an embodiment of the present invention;

FIG. 2 is a front view showing the configuration of the digital signal demodulation unit, which shows an embodiment of the present invention;

FIG. 3 is a plan view of a circuit board showing a board layout structure having a digital tuner placed at a left end, which shows an embodiment of the present invention;

FIG. 4 is a plan view of the circuit board showing the board layout structure having a digital tuner placed at a right end with the digital signal demodulation unit inversely placed adjacently to the digital tuner, which shows an embodiment of the present invention;

FIG. 5 is a perspective view of the conventionally and generally used circuit board showing the configuration of the digital signal demodulation unit;

FIG. 6 is a front view of the conventionally and generally used circuit board showing the configuration of the digital signal demodulation unit;

FIG. 7 is a plan view of the conventionally and generally used circuit board showing the board layout structure having the digital tuner placed at the left end;

FIG. 8 is a plan view of the conventionally and generally used circuit board showing the board layout structure having the digital tuner placed at the right end with the digital signal demodulation unit placed adjacently to the digital tuner; and

FIG. 9 is a plan view of the circuit board showing the board layout structure having the digital signal demodulation unit inversely placed in the board layout structure shown in FIG. 8.

### DETAILED DESCRIPTION OF THE PREFERRED EMBODIMENTS

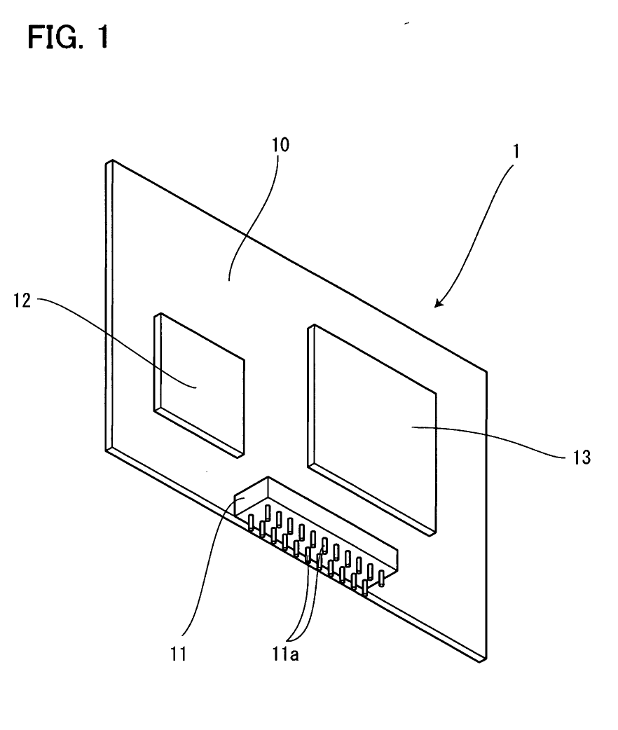

Examples as preferred embodiments of the present invention will be described hereunder with reference to FIGS. 1 to 9. It goes without saying that the present invention is easily applicable to those other than what is described in the examples without departing from the scope of the invention.

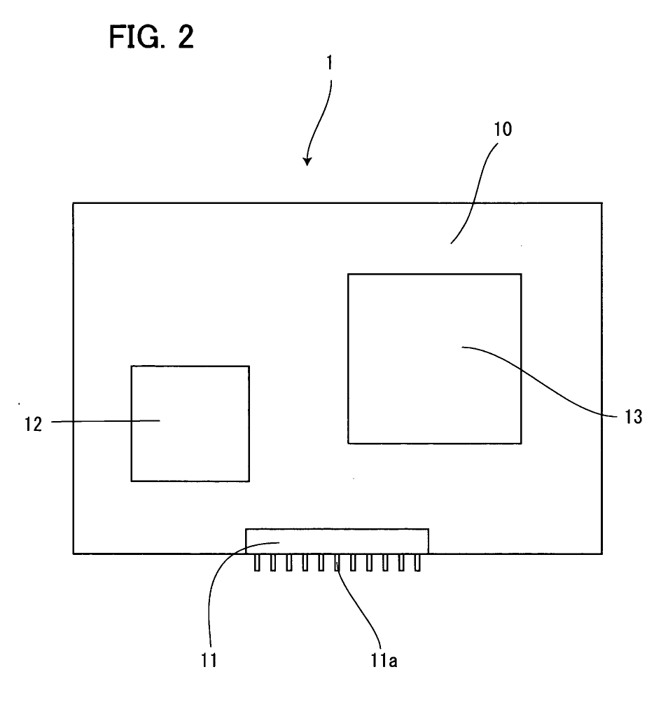

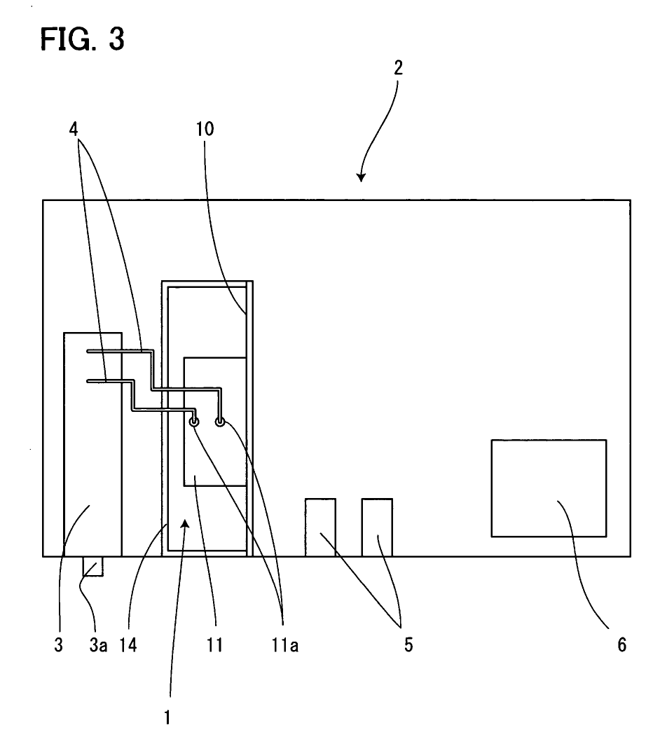

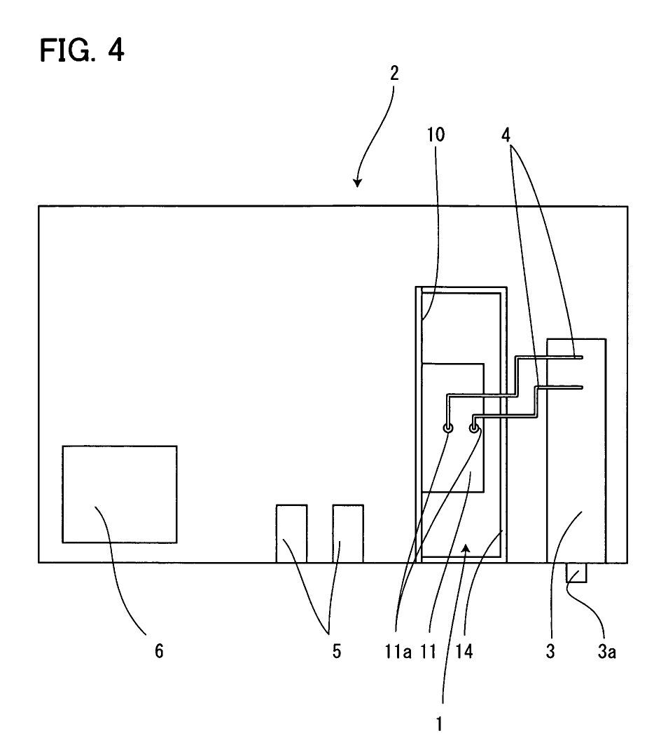

FIGS. 1 to 4 show the embodiments of the present invention. FIG. 1 is a perspective view showing a configuration of a digital signal demodulation unit according to this embodiment. FIG. 2 is a front view showing the digital signal demodulation unit. FIG. 3 is a plan view showing a state of mounting the digital signal demodulation unit, a digital tuner and other electronic components on a circuit board. FIG. 4 is a plan view of the circuit board showing the reversed state of a right and left positional relation of the digital signal demodulation unit and the digital tuner of FIG. 3.

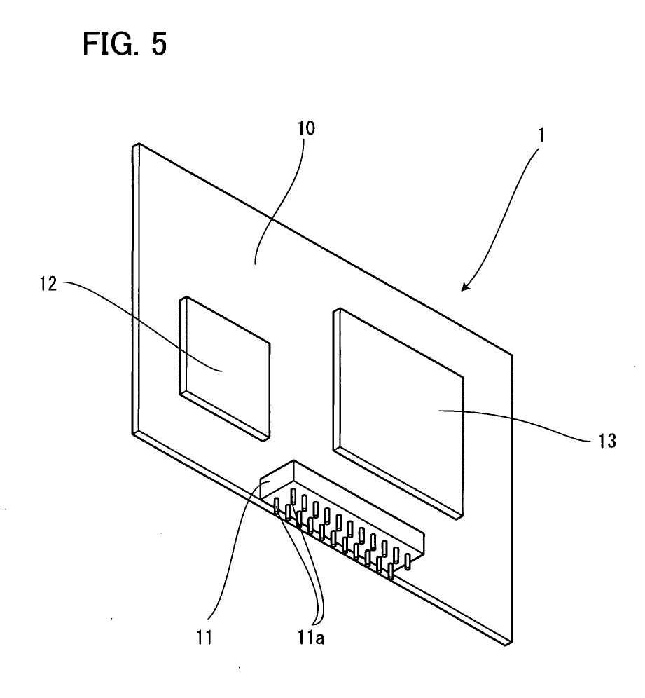

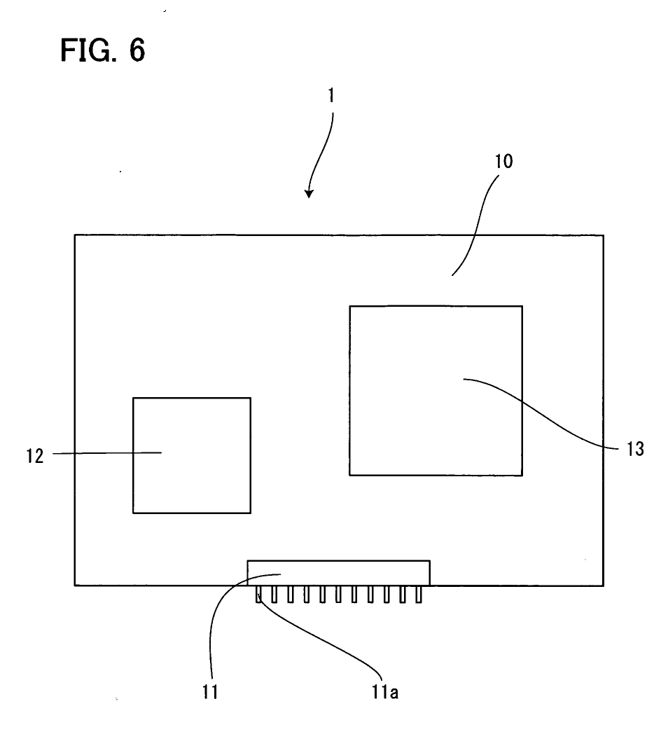

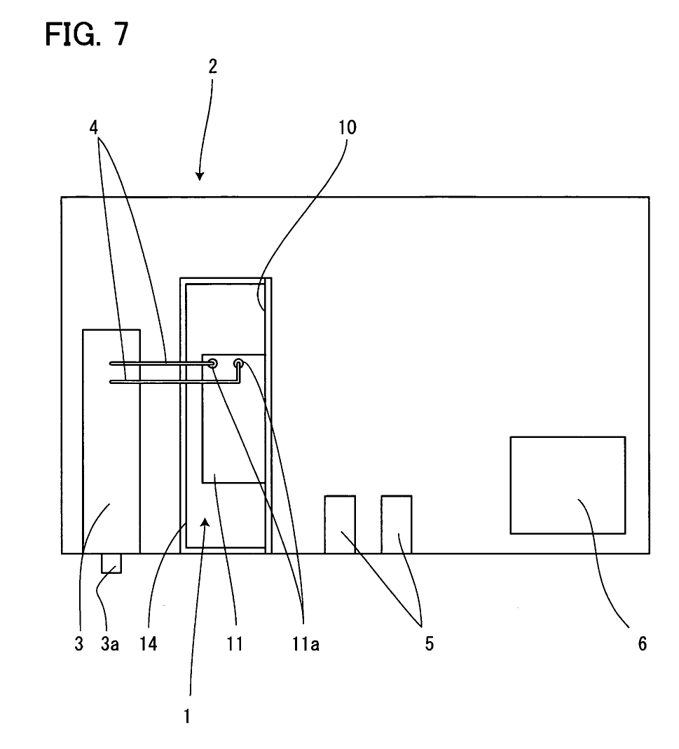

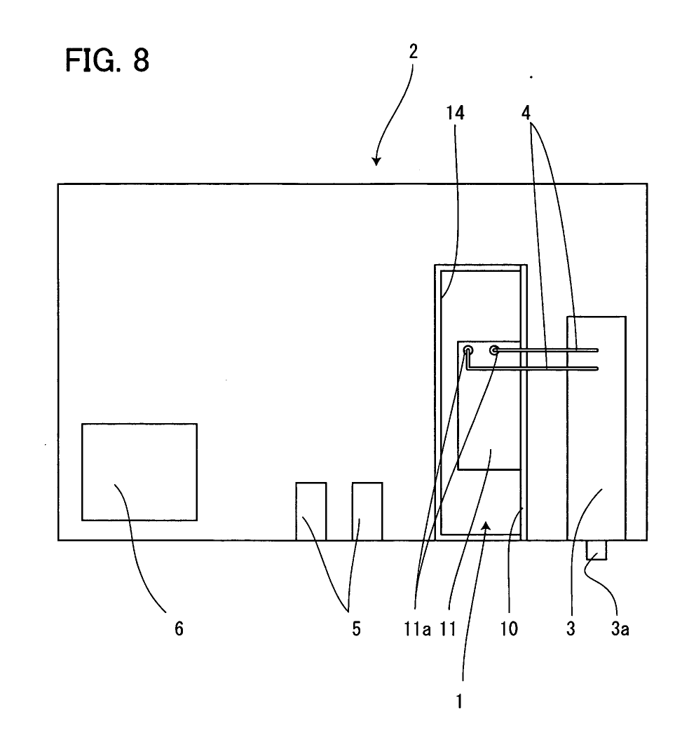

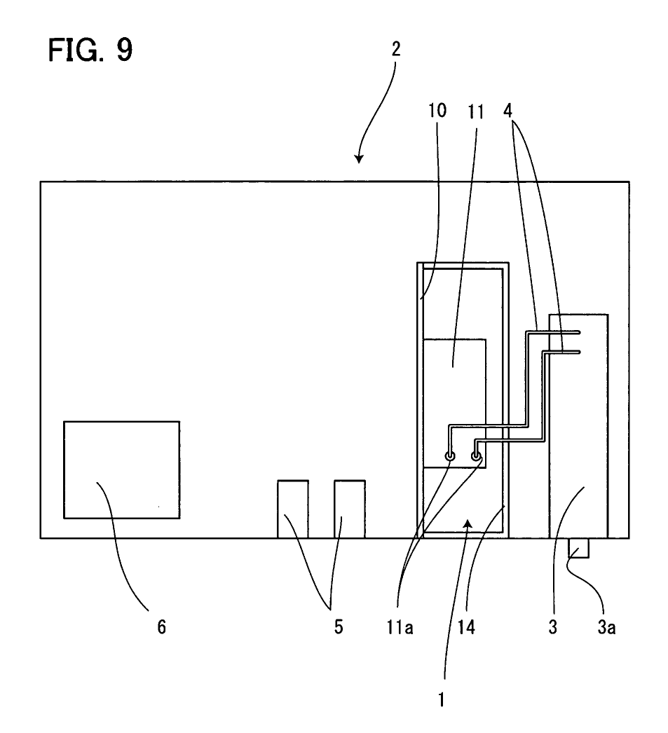

FIGS. 5 to 9 show a board layout structure of a digital broadcast receiving portion of the circuit board conventionally and generally used, in which an IF input terminal of the digital signal demodulation unit is positioned at an end of a connector. FIG. 5 is a perspective view showing the digital signal demodulation unit having the position of the IF input terminal placed at the connector end. FIG. 6 is a front view of the digital signal demodulation unit shown in FIG. 5. FIG. 7 is a plan view of the circuit board showing the state having the digital signal demodulation unit placed to the right of a digital tuner terminal portion of the digital tuner. FIG. 8 is a plan view of the circuit board showing the state having the digital signal demodulation unit placed to the left of the digital tuner without changing orientation of the digital signal demodulation unit shown in FIG. 7. FIG. 9 is a plan view of the circuit board showing the state having changed the orientation of the digital signal demodulation unit from the board layout structure shown in FIG. 8 in order to place a shield provided to the digital signal demodulation unit on the digital tuner side.

A description will be given based on FIGS. 1 and 2 as to a configuration of the digital signal demodulation unit to be mounted on the circuit board in this example. Reference numeral 1 denotes a digital signal demodulation unit for demodulating an encoded digital signal inputted from the digital tuner described later. Reference numeral 10 denotes a digital signal demodulation board, which includes the components described later and pattern wiring for electrically connecting them. Reference numeral 11 denotes a connector for electrically connecting the digital signal demodulation unit 1 to the circuit board described later. Reference numeral 11a denotes an IF input terminal for inputting a digital IF signal outputted by the digital tuner described later to the digital signal demodulation unit 1, which is positioned at the center as against the ends of the connector 11. Reference numeral 12 denotes an LSI for demodulating the digital IF signal, and reference numeral 13 denotes an LSI for decoding and imaging the demodulated digital IF signal.

Next, the configuration of the digital signal demodulation unit 1 and other electronic components on the circuit board will be described based on FIG. 3. Reference numeral 2 denotes a circuit board on which the electronic components are mounted and the pattern wiring is printed. Reference numeral 3 denotes an aforementioned digital tuner including an antenna connecting terminal 3a for connecting to an unshown antenna for receiving airwaves. Reference numeral 4 denotes a pattern wiring for transmitting the digital IF signal, which is intended to electrically connect the digital tuner 3 to the IF input terminal 11a. Reference numeral 5 denotes an audiovisual jack for connecting to an external electronic device and exchanging audio/video signals. Reference numeral 6 denotes an FBT (FlyBack Transformer) used to accelerate an electron beam radiated in a cathode-ray tube. Reference numeral 14 denotes a metallic shield for preventing digital noise generated by the digital tuner 3 from interfering with the digital signal demodulation unit 1 and also improving a radiation effect of the LSIs 12 and 13, which is formed to seal the electronic components and connector 11 mounted on the digital signal demodulation unit 1.

Next, a description will be given as to the board layout structure capable of keeping the performance of the digital signal demodulation unit 1 even independently from mutual positional relation between the digital signal demodulation unit 1 and the digital tuner 3. The digital IF signal is outputted from the digital tuner 3. As shorter pattern wiring is desirable as to the connection from the digital tuner 3 to the digital signal demodulation unit 1 for transmitting the digital IF signal in consideration of mixing of noise into the connection route, the digital tuner 3 and the digital signal demodulation unit 1 are adjacently laid out. To prevent the digital noise generated by the digital tuner 3 from interfering with the digital signal demodulation unit 1, the digital signal demodulation unit 1 is placed so that the shield 14 and digital tuner 3 mounted thereon face each other. To be more specific, the placement is as shown in FIG. 3 in the case where the digital tuner 3 is placed at the left end of the circuit board 2. Inversely, in the case where the digital tuner 3 is placed at the right end of the circuit board, the shield 14 of the digital signal demodulation unit 1 is not positioned to face the digital tuner 3 just by reversing the mutual positional relation between the digital signal demodulation unit 1 and the digital tuner 3 as in FIG. 8, and so digital noise interference occurs. To prevent it, the digital signal demodulation unit 1 is inversely placed as shown in FIG. 4 so as to have the shield 14 face the digital tuner 3. In this case, the IF input terminal 11a is placed at the center of the connector so that length of the pattern wiring connecting the digital tuner 3 to the IF input terminal 11a becomes fixed in both the states of FIGS. 3 and 4.

In this example configured as above, in the case where the digital tuner 3 is placed at the right end of the circuit board 2 by placing the IF input terminal 11a of the digital signal demodulation unit 1 at the center of the connector 11, the digital signal demodulation unit 1 can be placed on the left of the digital tuner 3 to have the side on which the shield 14 is mounted face the digital tuner 3 side. In the case where the digital tuner 3 is placed at the left end of the circuit board 2, the digital signal demodulation unit 1 can be placed with the side on which the shield 14 is mounted facing the digital tuner 3. It is thereby possible to realize the board layout structure capable of keeping the even performance independently from mutual positional relation between the digital signal demodulation unit 1 and the digital tuner 3, wherein the placement of the digital signal demodulation unit 1 and the digital tuner 3 is selectable between right and left. It is also possible, by rendering the shield 14 to be mounted on the digital signal demodulation unit 1 approximately U-shaped, to securely prevent the digital noise interference irrespective of the mutual positional relation between the digital signal demodulation unit 1 and the digital tuner 3 even in the case where the digital signal demodulation unit 1 is placed to have the shield 14 face the digital tuner 3 side for the sake of preventing digital noise generated by the digital tuner 3 from interfering with the digital signal demodulation unit 1.

The effects of the present invention are as follows.

A board layout structure of a digital broadcast receiving portion according to a first aspect is the one of a circuit board including on one surface a digital signal demodulation unit having a shield for preventing noise and a digital tuner for receiving digital airwaves and obtaining a signal, wherein an IF input terminal provided to a connector for electrically connecting to the circuit board of the digital signal demodulation unit is placed at a center of the connector so that mutual positional relation between the digital tuner and the digital signal demodulation unit on the circuit board is interchangeable between right and left. Therefore, it is possible to keep a constant length of pattern wiring for electrically connecting the IF input terminal of the digital signal demodulation unit to the IF output portion of the digital tuner whether the digital signal demodulation unit is placed on the right or on the left of the digital tuner. It is thus possible to give even performance without performance differences in digital signal demodulation due to pattern wiring length and handle multiple board layouts without using a particular structure.

The board layout structure of a digital broadcast receiving portion according to the second aspect is the board layout structure of a digital broadcast receiving portion according to the first aspect, wherein the shield is formed to contact the end of the digital signal demodulation unit and seal the connector and electronic components. Therefore, it is possible to prevent digital noise interference irrespective of the mutual positional relation between the digital tuner and the digital signal demodulation unit so as to secure highly accurate digital signal transfer.

What is claimed is:

1. A board layout structure of a digital broadcast receiving portion of a circuit board including on one surface a digital signal demodulation unit having a shield for preventing noise and a digital tuner for receiving digital airwaves and obtaining a signal, wherein an IF input terminal provided to a connector for electrically connecting to the circuit board of the digital signal demodulation unit is placed at a center of the connector so that mutual positional relation between the digital tuner and the digital signal demodulation unit on the circuit board is interchangeable between right and left.

2. The board layout structure of a digital broadcast receiving portion according to claim 1, wherein the shield is formed to contact an end of the digital signal demodulation unit and seal the connector and electronic components.
